(19) United States
(12) Patent Application Publication
(10) Pub. No.: US 2006/0192994 A1
(43) Pub. Date: Aug. 31, 2006

(54) Communication apparatus and communication method

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/340,107

(22) Filed: Jan. 26, 2006

(30) Foreign Application Priority Data
Feb. 28, 2005 (JP) 2005-054144

(51) Int. Cl. G06F 3/12

(52) U.S. Cl. 358/1.15

(57) ABSTRACT

A communication apparatus and method. Identification information statically allocated to a remote communication apparatus is designated. A domain name of the remote communication apparatus is presented to acquire an IP address by using a DNS service. A connection is made to a remote communication apparatus, to which the IP address acquired is allocated, to receive a response message. Information included in a predetermined section of the response message and all or a predetermined part of identification information designated are compared. When all or the predetermined part of the identification information coincides with the information included in the predetermined section of the response message, substantive data is transmitted to the remote communication apparatus connected.

### BACKGROUND OF THE INVENTION

1. Field of the Invention

The present invention relates to a communication apparatus and a communication method for performing peer-to-peer Internet Protocol (IP) communication. More specifically, the present invention relates to a communication apparatus and a communication method for directly making a connection to an apparatus with a destination IP address, which is acquired by a dynamic Domain Name System (DNS) service or a static DNS service, to perform data communication.

2. Description of the Related Art

A communication apparatus for performing IP communication may acquire a destination IP address by using a dynamic DNS service in order to perform data communication with a remote communication apparatus. The dynamic DNS service is realized by a dynamic DNS service server and a Dynamic Host Configuration Protocol (DHCP) server cooperating with each other. The dynamic DNS server transfers information to and receives information from the DHCP server at anytime. The dynamic DNS server adds and deletes a correspondence relation between a domain name of a DHCP client and an IP address thereof in a zone file of the dynamic DNS server. Therefore, the dynamic DNS server provides a DNS client, that is, a communication apparatus requiring an IP address, with a latest IP address dynamically allocated by the DHCP server.

However, when the communication apparatus transmits data to an IP address acquired by using the dynamic DNS service, it is likely that the communication apparatus makes a connection to a communication apparatus, which has a domain name different from a destination domain name presented to the dynamic DNS server, by mistake and transmits the data to the wrong communication apparatus.

For example, as illustrated in FIG. 4, a network environment may include a dynamic DNS service 18 in which a dynamic DNS server and a DHCP server cooperate with each other. In DNS service 18, routers 19 to 21 are connected to a network 17 and communication apparatuses 25 to 27 are connected to the routers 19 to 21, respectively. In this particular network environment, as illustrated in FIG. 5, at the beginning, an IP address X is allocated to the router 20 (S1). The communication apparatus 25 presents a domain name of the router 20 (the communication apparatus 26) to the dynamic DNS server 18 toacquire the IP address X allocated to the domain name in order to perform data communication with the communication apparatus 26 connected to the router 20 (S2) The communication apparatus 25 transmits data, such as electronic mail, to the IP address X acquired (S3).

However, when a situation (S4 to S6), as illustrated in FIG. 5, occurs between a point when the communication apparatus 25 acquires the IP address X (S2) and a point when the communication apparatus 25 starts transmission of the data (S3), a problem of wrong transmission of the data occurs. Between S2 and S3, an access between the router 20 and the dynamic DNS service 18 (the DHCP server 18) is disconnected because, for example, an error occurs in the router 20 (S4). The dynamic DNS service 18 (the DHCP server 18) sets the IP address X allocated to the router 20 in an idle state (S5). Another router 21 makes a connection to the dynamic DNS service 18 (the DHCP server 18) to receive allocation of the IP address X in the idle state (S6). In that case, the communication apparatus 25 inadvertently transmits data to the communication apparatus 27, which is the same type as the communication apparatus 26, connected to the router 21.

Such a problem of wrong transmission could occur when a destination IP address is acquired by using the dynamic DNS service. However, even when a destination IP address is acquired by using the static DNS service, if an IP address of a remote communication apparatus is changed accompanying a change of a setting or the like in the remote communication apparatus, it is still likely that wrong transmission of data occurs.

### BRIEF SUMMARY OF THE INVENTION

The present invention overcomes the problems described above. An advantage of the present invention is to provide a communication apparatus that can prevent wrong transmission that occurs because, between a point when the communication apparatus acquires an IP address by using a DNS service and a point when the communication apparatus makes a connection to a remote communication apparatus to which the IP address acquired is allocated, the remote communication apparatus is replaced with another communication apparatus.

In a first aspect of the present invention, a communication apparatus designates identification information statically allocated to a remote communication apparatus, and presents a domain name of the remote communication apparatus to acquire an IP address of the remote communication apparatus by using a DNS service. The communication apparatus makes a connection to the remote communication apparatus, to which the IP address acquired is allocated, to receive a response message. The communication apparatus transmits substantive data to the remote communication apparatus connected only when information included in a predetermined place of the response message and all or a predetermined part of the identification information designated coincide with each other.

In a second aspect of the present invention, the DNS service is a dynamic DNS service and the IP address is a dynamic IP address.

According to the present invention, when the communication apparatus acquires an IP address by using the DNS service and makes a connection to a remote communication apparatus at the IP address acquired, even if the remote communication apparatus at the time when the IP address is acquired is replaced with a communication apparatus different from the remote communication apparatus, the communication apparatus detects the replacement of the communication apparatus. Thus, it is possible to prevent the communication apparatus from transmitting data by mistake.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a constitution of a facsimile multifunction apparatus and an example of a network environment when a plurality of facsimile multifunction apparatuses perform data communication by using a dynamic DNS service according to a preferred embodiment of the present invention.

FIG. 2 is a flowchart illustrating an operation that is executed when facsimile multifunction apparatuses according to a first preferred embodiment of the present invention perform data transmission and reception with one another.

FIG. 3 is a flowchart illustrating an operation that is executed when facsimile multifunction apparatuses according to a second preferred embodiment of the present invention perform data transmission and reception with one another.

FIG. 4 is a drawing illustrating a network environment in which conventional communication apparatuses are connected.

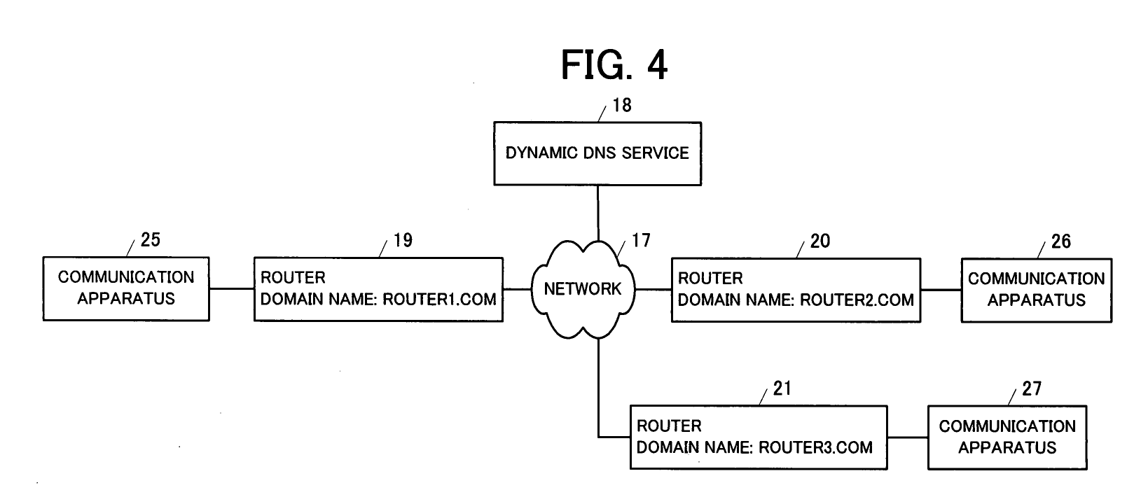

FIG. 5 is a drawing illustrating a procedure of communication that causes a problem when the conventional communication apparatuses execute data communication by using a dynamic DNS service.

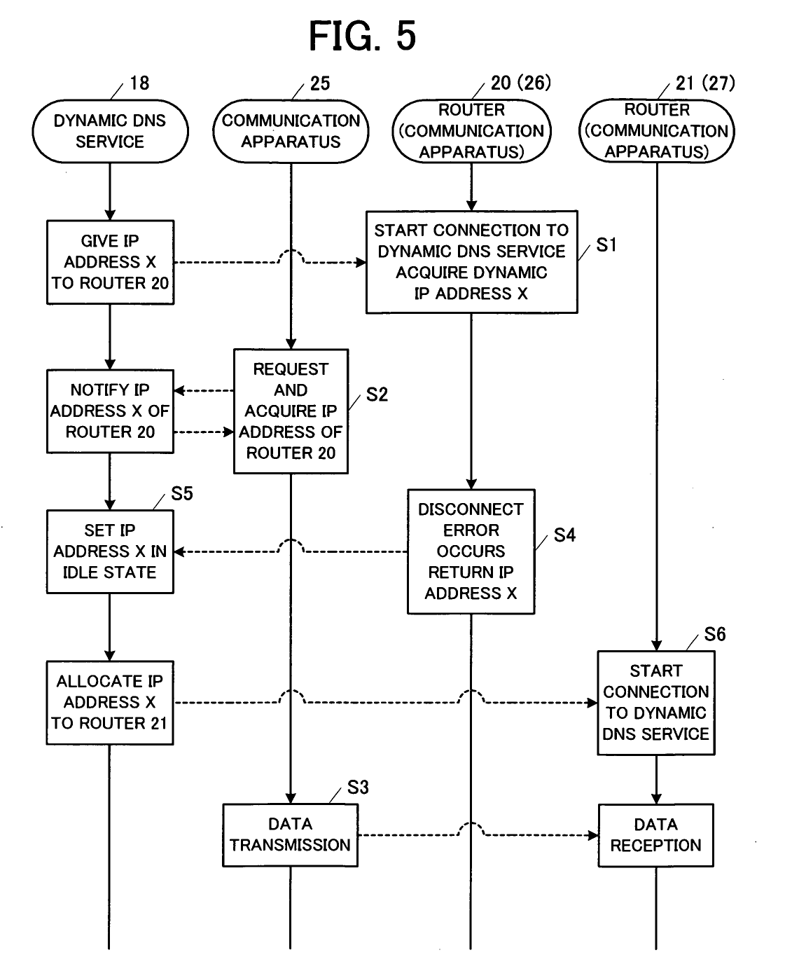

### DESCRIPTION OF THE PREFERRED EMBODIMENTS

A first preferred embodiment of the present invention will be hereinafter described. In this preferred embodiment, a facsimile multifunction apparatus including a facsimile communication function such as G3 for performing facsimile communication through a public switched telephone network and an Internet facsimile communication function for performing transmission of electronic mails through the Internet is described as an example. The present invention is applicable to a communication apparatus that directly makes a connection to a remote communication apparatus at an IP address acquired by a DNS service and performs peer-to-peer data communication. For example, the present invention is applicable not only to the facsimile multifunction apparatus but also to a communication apparatus including only the Internet facsimile communication function and IP communication apparatuses of other types.

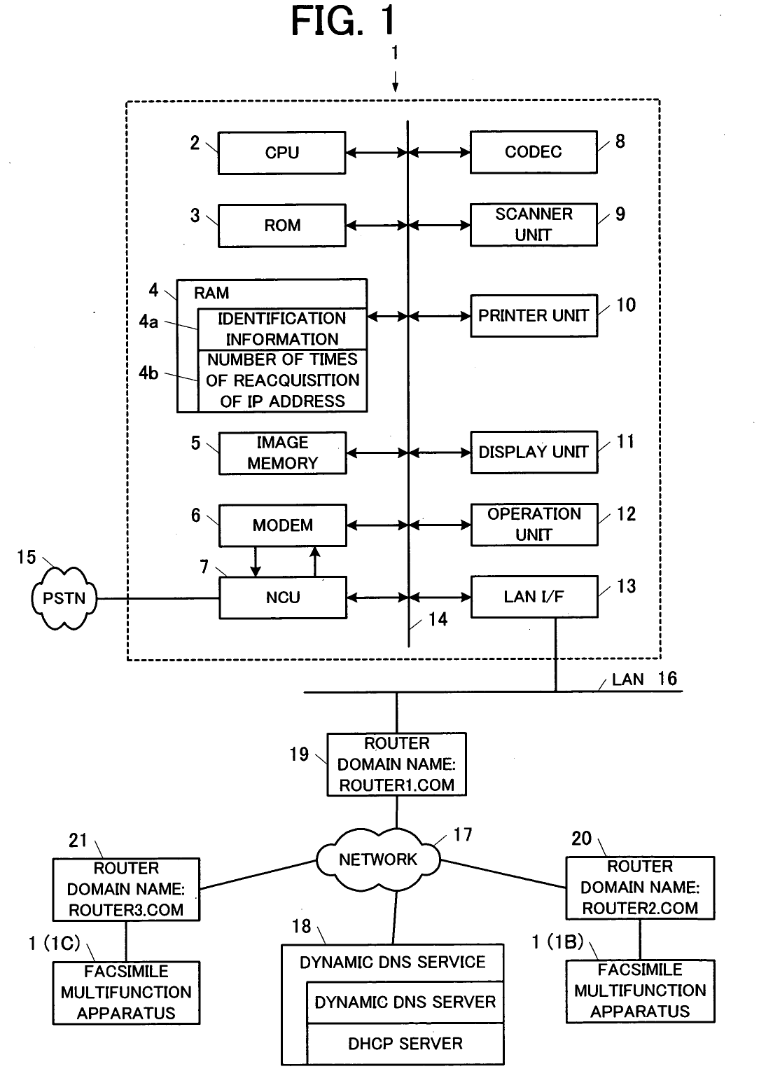

An example of a constitution of a facsimile multifunction apparatus 1 is illustrated in FIG. 1. The facsimile multifunction apparatus 1 includes a Central Processing Unit (CPU) 2, a Read Only Memory (ROM) 3, a Random Access Memory (RAM) 4, an image memory 5, a Modulator-Demodulator (MODEM) 6, a Network Control Unit (NCU) 7, a Coder Decoder (CODEC) 8, a scanner unit 9, a printer unit 10, a display unit 11, an operation unit 12, and a Local Area Network (LAN) interface 13. The respective units 2 to 13 are connected by a bus 14.

The CPU 2 controls the respective units constituting the facsimile multifunction apparatus 1 in accordance with a control program stored in the ROM 3. The ROM 3 stores the control program and the like. The RAM 4 functions as a main memory, a work area, and the like of the CPU 2. The RAM 4 stores identification information 4a of the facsimile multifunction apparatus 1 and a set value 4b of a number of times of reacquisition of IP address “K” described later. In this preferred embodiment, the identification information 4a is an e-mail address. However, the identification information 4a is not limited to an e-mail address and may be any information as long as the information is information peculiar to each communication apparatus statically (invariably) allocated to each communication apparatus.

For example, the identification information 4a may be a domain name, a telephone number, a facsimile number, or the like of the facsimile multifunction apparatus 1 instead of an e-mail address. The RAM 4 stores telephone directory data (not illustrated) such as a destination name, a destination e-mail address, and a destination facsimile number. The telephone directory data stored in the RAM 4 are referred to by a user when the user designates destination information by using one-touch and speed-dial functions in the operation unit 12 and the like.

The image memory 5 stores image data or the like compressed by the CODEC 8. The MODEM 6 performs modulation of transmission data and demodulation of reception data complying with the recommendation V.34 of the International Telecommunication Union (ITU)-T or a recommendation similar to the recommendation V.34. The NCU 7 performs connection of a line to and release of the line from a Public Switched Telephone Network (PSTN) 15 and, when necessary, connects the MODEM 6 to the PSTN 15. In performing facsimile transmission or the like, the CODEC 8 encodes image data according to the Joint Photographic Experts Group (JPEG) scheme, the Modified Huffman (MH) scheme, the Modified Relative Element Address Designate (MR) scheme, or the Modified MR (MMR) scheme, or the like. The CODEC 8 decodes received image data or the like.

The scanner unit 9 reads an image of an original. The scanner unit 9 includes a Charge Coupled Device (CCD) color line sensor, an Analog to Digital (A/D) converter, and an image processing circuit or the like. The printer unit 10 takes out a recording sheet from a sheet feeding cassette and records a received image, a read image, or the like on the recording sheet. The display unit 11 includes, for example, a Liquid Crystal Display (LCD) provided beside the operation unit 12 and displays various kinds of screen information. The operation unit 12 includes various operation keys. A user performs various kinds of operation on this operation unit 12.

The LAN interface 13 connects the facsimile multifunction apparatus 1 and a Local Area Network (LAN) 16. The facsimile multifunction apparatus 1 communicates with a client Personal Computer (PC) (not illustrated) and a router 19, which are also connected to the LAN 16, through the LAN interface 13. The facsimile multifunction apparatus 1 also communicates with another communication apparatus on a network 17 through the router 19.

The facsimile multifunction apparatus 1 including the constitution described above has a Simple Mail Transfer Protocol (SMTP) server function. The facsimile multifunction apparatus 1 can attach image data or the like of an original read by the scanner unit 9 to electronic mail and transmit the electronic mail with the image data. The facsimile multifunction apparatus 1 can also receive such electronic mail and, for example, print out an image data part attached to the electronic mail. The facsimile multifunction apparatus 1 also has a facsimile communication function such as Group 3 for transmitting or receiving image data or the like of an original through the PSTN 15.

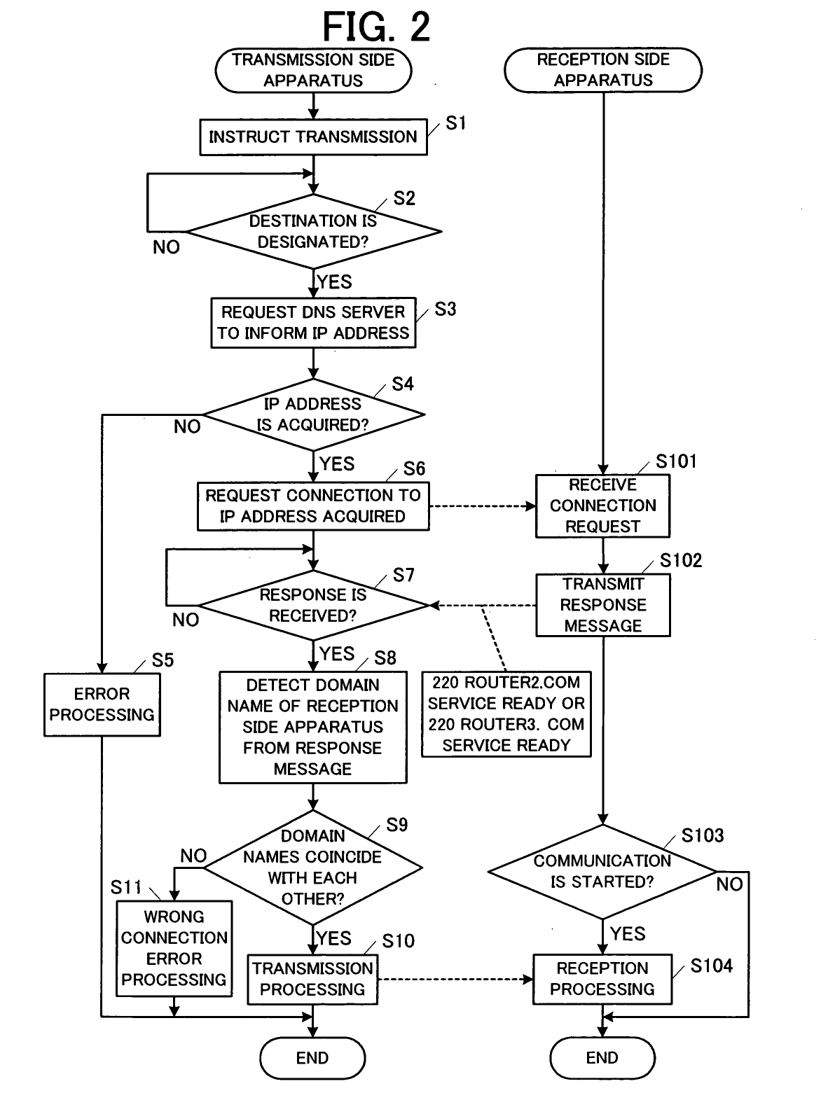

Operations carried out when the facsimile multifunction apparatuses 1 transmit and receive substantive data by using Internet facsimiles will be described with reference to a flowchart in FIG. 2. In this specification, the substantive data means data including substantive contents that should be transmitted from a transmission side to a reception side such as electronic mail and image data. In the following description, the facsimile multifunction apparatus 1 on the transmission side of the substantive data is referred to as a transmission side apparatus 1A. The facsimile multifunction apparatus 1 on the reception side of the substantive data is referred to as a reception side apparatus 1B or 1C. The operations to be described with reference to the flowchart are executed in accordance with instructions issued by the CPU 2 based on a program stored in the ROM 3 or the like of the respective facsimile multifunction apparatus 1.

In the transmission side apparatus 1A, an operation for instructing transmission of electronic mail is performed (S1). For example, when a destination e-mail address of the reception side apparatus 1B is designated (S2: YES), the transmission side apparatus 1A presents a domain name (“ROUTER2.COM”) of the destination e-mail address to the dynamic DNS service 18 and requests the dynamic DNS service 18 to inform an IP address corresponding to the domain name (S3). A designation of a destination e-mail address is performed by an input operation with the operation unit 12 or the like or a selection operation (e.g., an operation of a one-touch dial key or a speed-dial key) for a destination e-mail address registered as telephone directory data in advance.

When the transmission side apparatus 1A requests the dynamic DNS service 18 to inform an IP address (S3) but fails to acquire an IP address (S4: NO), the transmission side apparatus 1A performs error processing (S5). For example, the transmission side apparatus 1A outputs a message indicting that the transmission side apparatus 1A has failed to acquire an IP address. A form of the output is not specifically limited. The output is performed by, for example, display on the display unit 11 or printout with the printer unit 10. As an example of a case in which the transmission side apparatus 1A fails to acquire an IP address, it is conceivable that an error occurs in a remote router 20, an access between the router 20 and the dynamic DNS service 18 (the DHCP server 18) is disconnected, and the dynamic DNS service 18 (the DHCP server 18) sets an IP address allocated to the router 20 in an idle state.

When the transmission side apparatus 1A successfully acquires an IP address from the dynamic DNS service 18 (S4: YES), the transmission side apparatus 1A sends, through the remote router 20 or 21 to which the IP address acquired is allocated, a connection request to the reception side apparatus 1B or 1C connected to the remote router 20 or 21 designating an SMTP service port (S6).

When the reception side apparatus 1B or 1C receives the connection request (S101), the reception side apparatus 1B or 1C describes a domain name corresponding to a predetermined part of the identification information (the e-mail address) 4a of the reception side apparatus 1B or 1C in a predetermined section of an SMTP response message and returns the response message to the transmission side apparatus 1A. For example, the reception side apparatus 1B or 1C returns an SMTP response message “220 ROUTER2.COM Service Ready” or “220 ROUTER3.COM Service Ready”, in which a domain name “ROUTER2.COM” or “ROUTER3.COM” is described following an affirmative confirmation response code “220” for a connection request, to the transmission side apparatus 1A (S102). When the transmission side apparatus 1A makes a connection to the reception side apparatus 1B, the SMTP response message “220 ROUTER2.COM Service Ready” is returned to the transmission side apparatus 1A. When the transmission side apparatus 1A makes a connection to the reception side apparatus 1C, the SMTP response message “220 ROUTER3.COM Service Ready” is returned to the transmission side apparatus 1A.

When the transmission side apparatus 1A receives the SMTP response message from the reception side apparatus 1B or 1C (S7: YES), the transmission side apparatus 1A detects the predetermined section in the SMTP response message received, that is, the information “ROUTER2.COM” or “ROUTER3.COM” described following the SMTP response code “220” (S8). The transmission side apparatus 1A judges whether the domain name in the predetermined part of the destination e-mail address designated in S2 and the information coincide (S9). When it is judged that the domain name and the information coincide (S9: YES), that is, when the information is “ROUTER2.COM”, the transmission side apparatus 1A sends a transmission start command to the reception side apparatus connected to the transmission side apparatus 1A, executes an SMTP procedure with the reception side apparatus, and transmits electronic mail (S10).

On the other hand, when it is judged that the information and the domain name do not coincide (S9: NO), that is, when the information is “ROUTER3.COM”, the transmission side apparatus 1A considers that the transmission side apparatus 1A is connected by mistake and executes error processing (S11). As the error processing, the transmission side apparatus 1A sends a command for interrupting a transaction to the reception side apparatus connected to the transmission side apparatus 1A. The transmission side apparatus 1A informs a user of the transmission side apparatus 1A that the transmission side apparatus 1A is connected by mistake. The transmission side apparatus 1A outputs an error message such as “It seems that DNS registration information of the remote terminal is not updated. Please resend electronic mail after a while.” A form of the output is not limited. For example, display on the display unit 11, printout with the printer unit 10, or the like is performed.

On the other hand, when the reception side apparatus 1B receives the transmission start command from the transmission side apparatus 1A (S103: YES), the reception side apparatus 1B executes an SMTP procedure with the transmission side apparatus 1A and receives the electronic mail from the transmission side apparatus 1A (S104). On the other hand, when the reception side apparatus 1C receives the command for interrupting a transaction from the transmission side apparatus 1A, the reception side apparatus 1C considers that SMTP communication is not started (S103: NO) and disconnects a Transmission Control Protocol (TCP) connection.

In one aspect, as evident from the above description, it is possible to detect whether the transmission side apparatus 1A is connected by mistake by comparing a domain name described in a predetermined section of a response message received at the time of connection and a domain name (a predetermined part of identification information) of an e-mail address (identification information) designated at the time of transmission in the transmission side apparatus 1A. When the transmission side apparatus 1A is connected by mistake, the transmission side apparatus 1A can cancel e-mail transmission to a remote communication apparatus connected to the transmission side apparatus 1A.

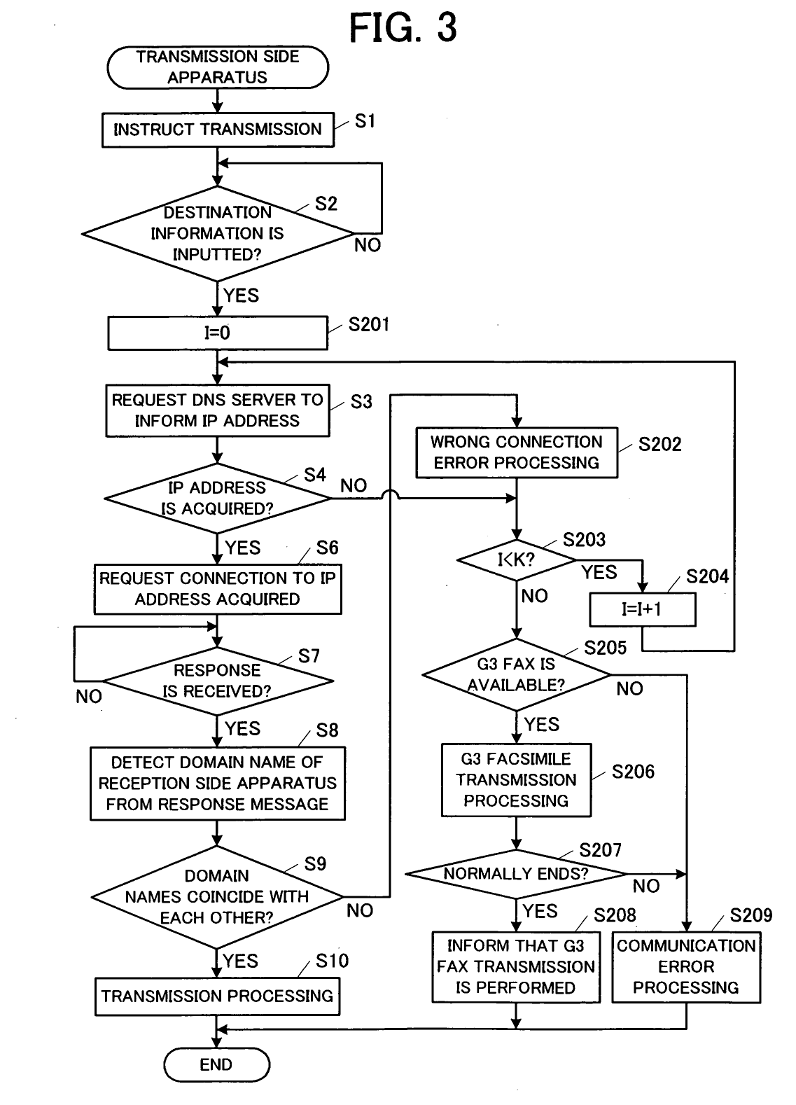

A facsimile multifunction apparatus according to a second preferred embodiment of the present invention will be described in detail with reference to a flowchart in FIG. 3. The facsimile multifunction apparatus according to the second preferred embodiment has a constitution and a communication function similar to those of the facsimile multifunction apparatus 1 according to the first preferred embodiment. However, the facsimile multifunction apparatus according to the second preferred embodiment is different from the facsimile multifunction apparatus 1 according to the first preferred embodiment in that the former has a function for automatically retrying transmission processing when a wrong connection is detected. In the second preferred embodiment, components and operations identical with those in the first preferred embodiment are denoted by the same reference numerals and signs and descriptions of the components and the operations are omitted.

When a transmission instruction operation is performed and a designation operation for a destination e-mail address is performed in the transmission side apparatus 1A (S2: YES), “0” is set in a variable “I” in the RAM 4 (S201). When the transmission side apparatus 1A judges in S9 that information described in a predetermined section in a received SMTP response message and a domain name of the destination e-mail address designated in S2 do not coincide with each other (S9: NO), the transmission side apparatus 1A performs wrong connection processing (S202). As the wrong connection processing, the transmission side apparatus 1A sends a command for interrupting a transaction to the reception side apparatus 1C connected to the transmission side apparatus 1A. The transmission side apparatus 1A may or may not inform the user that the transmission side apparatus 1A is connected by mistake.

When the transmission side apparatus 1A executes the operation in S202 and fails to acquire an IP address in S4, the CPU 2 of the transmission side apparatus 1A judges whether the variable “I” is less than the set value 4b of the number of times of reacquisition of an IP address “K” (S203). When the variable “I” is less than the set value 4b of “K” (S203: YES), the CPU 2 adds “1” to the variable “I” (S204) and returns the processing to S3.

On the other hand, when the variable “I” is equal to or larger than the set value 4b of the number of times of reacquisition of an IP address “K” (S203: NO), the CPU 2 refers to the telephone directory data registered in the RAM 4 and judges whether a facsimile number is registered for the reception side apparatus 1B with the destination e-mail address designated in S2 (S205). When a facsimile number of the reception side apparatus 1B is registered (S205: YES), the transmission side apparatus 1A transmits image data, which is planned to be transmitted by electronic mail, to the facsimile number using G3 facsimile communication (S206).

When the facsimile transmission processing ends normally (S207: YES), the transmission side apparatus 1A outputs a message indicating that the image data of the original is transmitted by the G3 facsimile communication rather than the Internet facsimile (S208). A form of the output is not specifically limited. For example, the message is displayed by the display unit 11 and printed out by the printer unit 10.

When the facsimile transmission processing does not end normally (S207: NO), the transmission side apparatus 1A outputs a message indicating that, for example, the transmission side apparatus 1A is connected by mistake, the transmission side apparatus 1A has retried connection but has not been connected normally, or the image data could not be transmitted even by the G3 facsimile. A form of the output is not specifically limited as described above. The output is performed by display, printing, or the like (S209).

As described above, when a wrong connection occurs, the facsimile multifunction apparatus 1A according to the second preferred embodiment of the present invention automatically attempts to reacquire an IP address and reconnection without transmitting the image data. The facsimile multifunction apparatus 1A also attempts reacquisition of an IP address when the facsimile multifunction apparatus 1A fails to acquire an IP address in S4. Therefore, the facsimile multifunction apparatus 1A can automatically start communication with the reception side apparatus 1B connected to the remote router 20 at a stage when the router 20 recovers from an error and connected to the dynamic DNS service 18 (the DHCP server 18).

Even if the remote router 20 does not recover from an error in a fixed time, when the reception side apparatus 1B has the G3 facsimile communication function, the facsimile multifunction apparatus 1A automatically transmits the image data to the reception side apparatus 1B according to the G3 facsimile communication. In this way, in the facsimile multifunction apparatus 1A, an operation burden on a user for performing retransmission is significantly reduced.

In the description of the first and the second preferred embodiments, the facsimile multifunction apparatus 1 acquires an IP address by using the dynamic DNS service 18 and performs communication. However, the facsimile multifunction apparatus 1 can prevent wrong transmission even when the dynamic DNS service 18 is replaced with a static DNS service. For example, from a point when the transmission side apparatus 1A acquires an IP address of a remote apparatus by using the static DNS service until the transmission side apparatus 1A makes a connection to the remote apparatus, even if the IP address of the remote apparatus is changed to another IP address accompanying a change of a setting or the like of the remote apparatus, wrong transmission is prevented if a domain name statically allocated to the transmission side apparatus 1A is not changed.

In the first and the second preferred embodiments, the Internet facsimile communication according to the SMTP is described as an example of the IP communication. However, a communication protocol is not limited the SMTP. Any communication protocol is applicable as long as, when a transmission side apparatus is connected to a reception side apparatus according to the TCP by using a DNS service, in the reception side apparatus, it is possible to include identification information statically allocated to the reception side apparatus or a predetermined part of the identification information in a predetermined section of a response message.

In the description of the first and the second preferred embodiments, an e-mail address is applied as identification information statically allocated to a communication apparatus. However, the identification information is not limited to an e-mail address and may be a domain name, an IP telephone number, a facsimile number, a company name, a group name, a manufacturing number of the apparatus, or the like. For example, when a group name is applied as the identification information, in S2, the facsimile multifunction apparatus 1A requests the user to perform an operation for designating a group name (input operation, selection operation, etc.) as well as an operation for designating destination information (a destination e-mail address).

In S9, when the group name (the identification information) designated together with the destination information and the information (the identification information) described in the predetermined section in the SMTP response message in S8 coincide with each other, the facsimile multifunction apparatus 1A sends a transmission start command to the reception side apparatus connected to the facsimile multifunction apparatus 1A and forms an SMTP procedure between the facsimile multifunction apparatus 1A and the reception side apparatus to transmit electronic mail (S10).

When it is judged that the group name and the information do not coincide with each other (S9: NO), considering that the facsimile multifunction apparatus 1A is connected by mistake, the facsimile multifunction apparatus 1A executes the error processing in S11 (in case of the first preferred embodiment) or executes the operation for shifting to S202 (in case of the second preferred embodiment). On the other hand, the reception side apparatus is given a means for generating, when a connection request is received, an SMTP response message, in a predetermined section of which the group name (the identification information) registered in the reception side apparatus is described, and returning the SMTP response message.

In the first and the second preferred embodiments, the facsimile multifunction apparatus is described as an example. However, it is possible to give the function according to the present invention to a general-purpose computer such as a personal computer. That is, it is possible to give the same function as the facsimile multifunction apparatus 1 according to the preferred embodiments of the present invention to the general-purpose computer by installing facsimile communication software incorporating a program for executing the processing performed by the facsimile multifunction apparatus 1 in the general-purpose computer.

As functions of the G3 facsimile apparatus, a closed network function for performing reception only when a pass code notified from a remote apparatus and a pass code set in advance in the own apparatus coincide with each other, a security function for accumulating originals received in a set time frame such as the night in a memory and not printing out the originals, and the like are known. The facsimile multifunction apparatus (the communication apparatus) according to the first and the second preferred embodiments is markedly different from the facsimile apparatus having these functions in terms of a constitution and an effect.

The facsimile multifunction apparatus according to the preferred embodiments of the present invention is markedly different from the conventional facsimile apparatus. For example, the facsimile multifunction apparatus according to the present invention can prevent wrong connection by detecting coincidence or non-coincidence of identification information (all or a part) inputted and designated as information on a transmission destination on a transmission side and information included in a response at the time of connection and returned by a reception side. In another example, the facsimile multifunction apparatus according to the preferred embodiments of the present invention detects wrong connection and, after the transmission side stops transmission, notifies that DNS registration information is not updated. Moreover, in still another example, after a wrong connection, the facsimile multifunction apparatus of the present invention executes acquisition of a new IP address and retrial of transmission to a communication apparatus with the IP address acquired according to execution of, for example, the processing in S203, S204, and the like.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the invention.

What is claimed is:

1. A communication apparatus, comprising:
a unit that designates identification information statically allocated to a remote communication apparatus;
a unit that presents a domain name of the remote communication apparatus to acquire an Internet Protocol (IP) address by using a Domain Name System (DNS) service;
a unit that makes a connection to a remote communication apparatus, to which the IP address acquired is allocated, to receive a response message; and
a unit that transmits, only when information included in a predetermined section of the response message received and all or a predetermined part of the identification information designated coincide with each other, substantive data to the remote communication apparatus connected.

2. The communication apparatus according to claim 1, further comprising:
a unit that detects a domain name from the response message; and
a unit that judges whether the domain name detected coincides with the domain name presented in advance.

3. The communication apparatus according to claim 1, further comprising a unit that prevents, when the information included in the predetermined section of the response message and at least the predetermined part of the identification information designated do not coincide with each other, transmission of the substantive data.

4. The communication apparatus according to claim 3, further comprising a unit that informs a user of an error, when the transmission of the substantive data is prevented.

5. The communication apparatus according to claim 3, further comprising:
a unit that presents, when the transmission of the substantive data is prevented, the domain name of the remote communication apparatus to acquire an Internet Protocol (IP) address again;
a unit that makes a connection to a remote communication apparatus, to which the IP address acquired is allocated, to receive a response message; and
a unit that transmits the substantive data to the remote communication apparatus connected, only when information included in a predetermined section of the response message received and all or a predetermined part of the identification information designated coincide with each other.

6. The communication apparatus according to claim 5, further comprising:
a unit that counts a number of times the transmission of the substantive data is prevented;
a unit that judges that the number of times exceeds a predetermined value; and
a unit that transmits, when the number of times exceeds the predetermined value, the substantive data to the remote communication apparatus according to facsimile communication.

7. The communication apparatus according to claim 6, further comprising a unit that stores a telephone number for the facsimile communication in association with the domain name.

8. The communication apparatus according to claim 7, further comprising a unit that informs an error, when a telephone number for the facsimile communication is not stored in association with the domain name.

9. The communication apparatus according to claim 1, wherein the Domain Name System (DNS) service is a dynamic DNS service, and the Internet Protocol (IP) address is a dynamic IP address.

10. The communication apparatus according to claim 1, further comprising a unit that requests a connection from the remote communication apparatus according to an SMTP to receive a response message of the remote communication apparatus.

11. A communication method, comprising the steps of:
designating identification information statically allocated to a remote communication apparatus;
presenting a domain name of the remote communication apparatus to acquire an Internet Protocol (IP) address by using a DNS service;
making a connection to a remote communication apparatus, to which the IP address acquired is allocated, to receive a response message;
comparing information included in a predetermined section of the response message and all or a predetermined part of the identification information designated; and
transmitting substantive data to the remote communication apparatus connected, when all or the predetermined part of the identification information coincides with the information included in the predetermined section of the response message.

12. The communication method according to claim 11, further comprising the step of preventing transmission of the substantive data to the connected remote communication apparatus, when all or the predetermined part of the identification information does not coincide with the information included in the predetermined section of the response message.

13. The communication method according to claim 12, further comprising the step of informing, when the transmission of the substantive data is prevented, a user of the prevention of the transmission of the substantive data.

14. The communication method according to claim 12, further comprising the steps of:
presenting the domain name of the remote communication apparatus to acquire an Internet Protocol (IP) address again by using the Domain Name System (DNS) service;
making a connection to a remote communication apparatus, to which the IP address acquired is allocated, to receive a response message;
comparing information included in a predetermined section of the response message and all or a predetermined part of the designated identification information; and
transmitting the substantive data to the remote communication apparatus connected, when all or the predetermined part of the identification information coincides with the information included in the predetermined section of the response message.

15. The communication method according to claim 14, further comprising the step of preventing transmission of the substantive data to the connected remote communication apparatus, when all or the predetermined part of the identification information does not coincide with the information included in the predetermined section of the response message.

16. The communication method according to claim 15, further comprising the step of transmitting the substantive data to the remote communication apparatus according to facsimile communication if the facsimile communication is possible, when a number of times the transmission of the substantive data to the remote communication apparatus is prevented exceeds a predetermined number of times.

17. The communication method according to claim 16, further comprising the step of informing a user of the transmission of the substantive data, when the substantive data is transmitted to the remote communication apparatus according to the facsimile communication.

18. The communication method according to claim 16, further comprising the step of informing an error when the facsimile communication to the remote communication apparatus is impossible.

19. The communication method according to claim 11, further comprising the step of making a connection to the remote communication apparatus according to a Simple Mail Transfer Protocol (SMTP) to receive a response message from the remote communication apparatus.

20. The communication method according to claim 11, further comprising the steps of:
detecting a domain name from the response message received; and
comparing the domain name detected with the domain name of the remote communication apparatus.
